(19) United States
(12) Patent Application Publication
(10) Pub. No.: US 2022/0190670 A1
(43) Pub. Date: Jun. 16, 2022

(54) ROTATING ELECTRICAL MACHINE WITH INTEGRATED CONTROL DEVICE

(71) Applicant: Mitsubishi Electric Corporation, Tokyo (JP)

(72) Inventors: Yosuke UNO, Tokyo (JP); Yoshinobu UTSUMI, Tokyo (JP); Jun TAHARA, Tokyo (JP); Hiroyuki HIGASHINO, Tokyo (JP); Tatsuya FUKASE, Tokyo (JP)

(73) Assignee: Mitsubishi Electric Corporation, Tokyo (JP)

(21) Appl. No.: 17/486,015

(22) Filed: Sep. 27, 2021

(30) Foreign Application Priority Data
Dec. 16, 2020 (JP) 2020-208059

(51) Int. Cl. H02K 5/14; H02K 7/18; H02K 9/22; H02K 9/28; H02K 11/05; H02K 13/00; H01R 39/38

(52) U.S. Cl. CPC H02K 5/141; H02K 7/1815; H02K 9/227; H01R 39/385; H02K 11/05; H02K 13/003; H02K 9/28

(57) ABSTRACT

In the rotating electrical machine with integrated control device provided with the drive unit and the inverter assembly, the brush holder that holds the brush is detachably attached to either the rear bracket side of the inverter assembly or the inverter assembly side of the rear bracket so that it is not necessary to provide a hole for incorporating the brush holder in the central part of the control module, and the radial dimension of the control module can be reduced.

### TECHNICAL FIELD

The present application relates to a rotating electrical machine with integrated control device.

### BACKGROUND ART

According to the embodiment of the conventional example, there is a hole in the center of the control board to assemble the brush holder in the center of the control board in the radial direction, the case with the built-in control board also has a hole in the center so that the brush holder can be attached and detached from the rear side.

### PRIOR ART DOCUMENT

### Patent Literature

[Patent Literature 1] JP 2019-205216 A

### DISCLOSURE OF INVENTION

### Technical Problem

According to the above-mentioned conventional technology, since the brush holder is attached to the inverter drive unit and then mounted from the rear side, and since the space for mounting the brush holder is arranged on the drive unit central axis side, it is necessary to make a hole in the center of the control board, parts can not be mounted in the center of the control board, since the control board parts are mounted while avoiding the holes, the case with the built-in control board also expands in the radial direction, there is a problem that the radial dimension of the entire inverter becomes large.

An object of the present application is to disclose a technology made in view of the above circumstances, and to make possible to reduce the radial dimension of a control module in a rotating electrical machine with integrated control device.

### Solution to Problem

The rotating electrical machine with integrated control device disclosed in the present application provides a drive unit having a rotor having a field winding, a stator and a rear bracket, and

an inverter assembly arranged on the rear side of the drive unit and having a slip ring provided on the outer circumference of the rotating shaft of the rotor, a field module that supplies a field current to the field winding via a brush that is in sliding contact with the slip ring, heat sink thermally connected to the field module, and a control module disposed on the rear side of the heat sink for controlling the field current by controlling the field module,

wherein; a brush holder that holds the brush is detachably attached to either the rear bracket side of the inverter assembly or the inverter assembly side of the rear bracket.

### Advantageous Effects of Invention

In the rotating electrical machine with integrated control device disclosed in the present application, since the brush holder for holding the brush is detachably attached to either the side of the rear bracket of the inverter assembly or the side of the inverter assembly of the rear bracket, it is not necessary to provide a hole for incorporating the brush holder in the central part of the control module, and the radial dimension of the control module can be reduced.

### BRIEF DESCRIPTION OF DRAWINGS

FIG. 1A is a view exemplarily showing the first embodiment of the present application, and is a vertical cross-sectional view of a rotating electrical machine with integrated control device.

FIG. 1B is a view exemplarily showing the first embodiment of the present application, and is an enlarged view of a part A surrounded by an alternate long and short dash line in FIG. 1A.

FIG. 2 is a view exemplarily showing the first embodiment of the present application, and is a perspective view of a main part before assembling the brush holder as viewed from the front side.

FIG. 3A is a view exemplarily showing the second embodiment of the present application, and is a perspective view of a main part before assembling the brush holder as viewed from the front side.

FIG. 3B is a view exemplarily showing the second embodiment of the present application, and is a partial cross-sectional view of a main part in FIG. 3A.

FIG. 4 is a view exemplarily showing the third embodiment of the present application, and is a perspective view of a main part before assembling the brush holder as viewed from the front side.

FIG. 5 is a view exemplarily showing the third embodiment of the present application, and is a vertical sectional view of a main part after assembling the brush holder.

FIG. 6 is a view exemplarily showing the fourth embodiment of the present application, and is a perspective view of a main part before assembling the brush holder as viewed from the front side.

FIG. 7 is a view exemplarily showing the fourth embodiment of the present application, and is a vertical sectional view of a main part after assembling the brush holder.

FIG. 8 is a view exemplarily showing the fifth embodiment of the present application, and is a perspective view of a main part before assembling the brush holder as viewed from the front side.

FIG. 9 is a view exemplarily showing the fifth embodiment of the present application, and is a vertical sectional view of a main part before assembling the brush holder.

FIG. 10 is a view exemplarily showing the sixth embodiment of the present application, and is a perspective view of a main part viewed from the front side.

FIG. 11 is a view exemplarily showing the seventh embodiment of the present application, and is a perspective view of a main part viewed from the front side.

FIG. 12 is a view exemplarily showing the eighth embodiment of the present application, and is a perspective view of a main part viewed from the front side.

FIG. 13 is a view exemplarily showing the ninth embodiment of the present application, and is a perspective view of a main part viewed from the front side.

FIG. 14 is a view exemplarily showing the ninth embodiment of the present application, and is a front view of a main part viewed from the front side.

FIG. 15 is a view exemplarily showing the tenth embodiment of the present application, and is a perspective view of a main part viewed from the front side.

FIG. 16 is a view exemplarily showing the tenth embodiment of the present application, and is a vertical sectional view of a main part.

FIG. 17 is a view exemplarily showing the eleventh embodiment of the present application, and is a perspective view of a brush holder which is a part of a main part as viewed from the front side.

FIG. 18 is a view exemplarily showing the eleventh embodiment of the present application, and is a perspective view of a slinger which is a part of a main part as viewed from the front side.

FIG. 19 is a view exemplarily showing the eleventh embodiment of the present application, which is an assembly explanatory view of a main part, and is a perspective view of a state in which a slinger is fitted in a step of the first step of the brush holder as viewed from the front side.

FIG. 20 is a view exemplarily showing the eleventh embodiment of the present application, and is a cross-sectional view of a state in which brush projection is suppressed by a slinger.

FIG. 21 is a view exemplarily showing the eleventh embodiment of the present application, which is an assembly explanatory view of a main part, and is a perspective view of a state in which a slinger is fitted in a second step of the brush holder as viewed from the front side.

FIG. 22 is a view exemplarily showing the eleventh embodiment of the present application, and is a cross-sectional view of a state in which the brush projection is not suppressed by the slinger.

FIG. 23 is a view exemplarily showing the twelfth embodiment of the present application, and is a perspective view of a main part viewed from the front side.

FIG. 24 is a view exemplarily showing the thirteenth embodiment of the present application, and is a perspective view of a slinger which is a part of a main part as viewed from the front side.

### DESCRIPTION OF EMBODIMENTS

Hereinafter, embodiments of the rotating electrical machine with integrated control device according to the present application will be described with reference to the drawings. Note that the present application is not limited to the following description, and can be appropriately modified without departing from the summary of the present application. In the following drawings, for easy understanding, the scales of the respective members may be different from the actual scales, and illustration of configurations not related to the features of the present application is omitted.

The first embodiment of the present invention will be described below with reference to the figures.

### First Embodiment

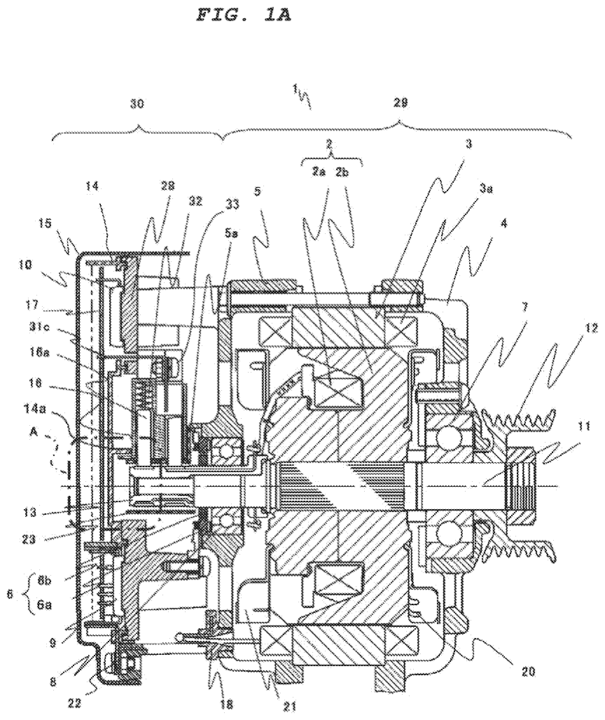

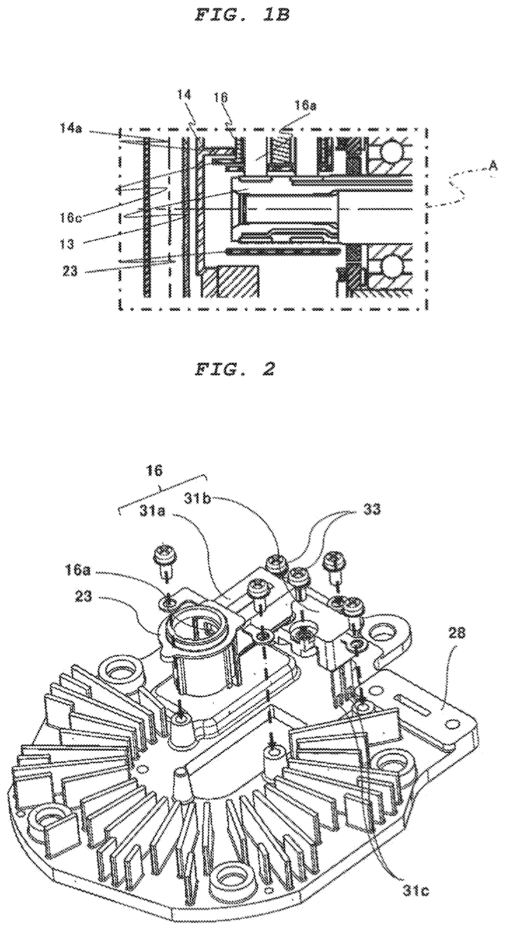

FIG. 1A is a view showing the first embodiment of the present application, and is a vertical cross-sectional view of a rotating electrical machine with integrated control device. FIG. 1B is a view showing the first embodiment of the present application, and is an enlarged view of a part A surrounded by an alternate long and short dash line in FIG. 1A. FIG. 2 is a view showing the first embodiment of the present application, and is a perspective view of a main part before assembling the brush holder as viewed from the front side.

In FIGS. 1A and 1B, a rotating electrical machine with integrated control device 1 is composed of a rotor 2 in which a field winding 2a is wound around a field iron core 2b, a stator 3 around which a three-phase stator winding 3a is wound, a front bracket 4 and a rear bracket 5 for accommodating the rotor 2 and the stator 3, a magnetic pole position detection sensor 6 that detects the rotational state of the rotor 2, a rectifier module 9 for supplying electric power to the field winding 2a, a field module 10, and a control module 17 that control them.

The rotating electrical machine with integrated control device 1 is composed of a drive unit 29 and an inverter assembly 30 as large components.

The specific structure of the drive unit 29 and the inverter assembly 30 will be described first with respect to the drive unit 29, and the inverter assembly 30 will then be described.

First, the drive unit 29 will be described.

The rotor 2 includes a rotating shaft 11 whose both ends are rotatably supported by the front bracket 4 and the rear bracket 5 via bearings 7 and 8, respectively. One end of the rotating shaft 11 projects to the front side from the front bracket 4, and a pulley 12 for transmitting and receiving torque in both directions with an internal combustion engine (not shown) is attached to the tip. The pulley 12 is connected to the internal combustion engine via a belt (not shown).

A slip ring 13 for supplying a field current to the field winding 2a of the rotor 2 is provided, and the slip ring 13 projects from the rear bracket 5 to the rear side. A brush 16a that is in sliding contact with the slip ring 13 for energizing the field winding 2a is built in a brush holder 16 to be movablely held in the direction of the slip ring 13.

The fans 20 and 21 for generating cooling air are mounted to the end faces of the field iron core 2b of the rotor 2.

The magnetic pole position detection sensor 6 is mounted coaxially with the rotating shaft 11 between the slip ring 13 and the bearing 8 on the rear side of the rear bracket 5, and detects the magnetic pole position of the rotating shaft 11, in other words, the rotor 2. The magnetic pole position detection sensor 6 is composed of a sensor stator 6a and a sensor rotor 6b, and the sensor rotor 6b having only an iron core is provided on the rotatable rotating shaft 11 inside the sensor stator 6a.

Next, the inverter assembly 30 will be described.

The inverter assembly 30 is composed of the rectifier module 9 which is a power module in which switching elements for supplying armature current during driving and rectifying armature current during power generation are integrated together with peripheral circuits, a field module 10 in which switching elements for controlling the field current are assembled together with peripheral circuits, a cooling heat sink 28 on which the rectifier module 9 and the field module 10 are mounted, a case 14 with terminals connected to the power system terminals of each module, and the control module 17 in which a control circuit for controlling the rectifier module 9 and the field module 10 is configured.

The sensor stator 6a of the magnetic pole position detection sensor 6 is mounted on the heat sink 28, and the signal wiring is connected to the control module 17.

A signal terminal connector and a battery connection terminal (not shown) are electrically connected to the case 14 and the control module 17.

As shown in FIGS. 1A, 1B and 2, the brush holder 16 is mounted on the drive side, in other words, the front side of the inverter assembly 30. Also, as illustrated in FIGS. 1A, 1B, and 2, a slinger 23 is assembled to the brush holder 16 for the purpose of temporarily holding the brush 16a during assembly, waterproofing the brush 16a and the slip ring 13, and preventing foreign matter from entering from the outside, the slinger 23 is fixed to the inverter assembly 30 with screws via the heat sink 18 in a state of being assembled to the brush holder 16.

As illustrated in FIGS. 1A and 1B, the axial length and position of the cylindrical slinger 23 is located at the front end face that does not come into contact with the sensor rotor 6b, and at the rear end face that does not come into contact with the case 14. Further, the end face of the cylindrical slinger 23 on the rear side in the axial direction is configured so as not to come into contact with the peripheral wall of the central hole of the heat sink 28, and is located on the front side of the axial rear end of the hole in the center of the heat sink 28. The space directly below the cylindrical slinger 23 communicates with the external space of the rotating electrical machine with integrated control device 1 through a space between the heat sink 28 and the rear bracket 5. The salt water or water that have been applied to the outer peripheral surface of the cylindrical slinger 23 come along the outer peripheral surface of the cylindrical slinger 23, from the space directly under the slinger 23, through the space between the heat sink 28 and the rear bracket 5, and drops into the external space of the rotating electrical machine with integrated control device 1.

After assembling the inverter assembly, the inverter assembly 30 is fixed to the boss provided on the rear side of the rear bracket 5 of the drive unit 29 on which a connecting board 18 is mounted by the screws 22.

After that, to protect the inverter assembly 30 attached to the outside of the rear bracket 5 on the rear side from being exposed to water such as salt and muddy water, and to insulate from the engine peripheral members, a cover 15 is attached to the case 14 by screws (not shown), the inverter assembly 30 is built in and protected.

As described above, when the brush holder 16 is mounted from the rear side, a space or hole for assembling the brush holder 16 in the axial direction is required to assemble the brush holder 16 in the control module 17 and the case 14, but according to the first embodiment, by fixing the brush holder 16 to the case 14 from the front side, the case 14 and the control module 17 can be configured without making a space and a hole for assembling the brush holder 16, a board mount components and a board circuit can be placed in the center of the board, it becomes possible to reduce the size of the entire board, and since the case 14 can be made smaller accordingly, the radial size of the entire inverter assembly can be suppressed.

### Second Embodiment

The second embodiment of the present application will be described.

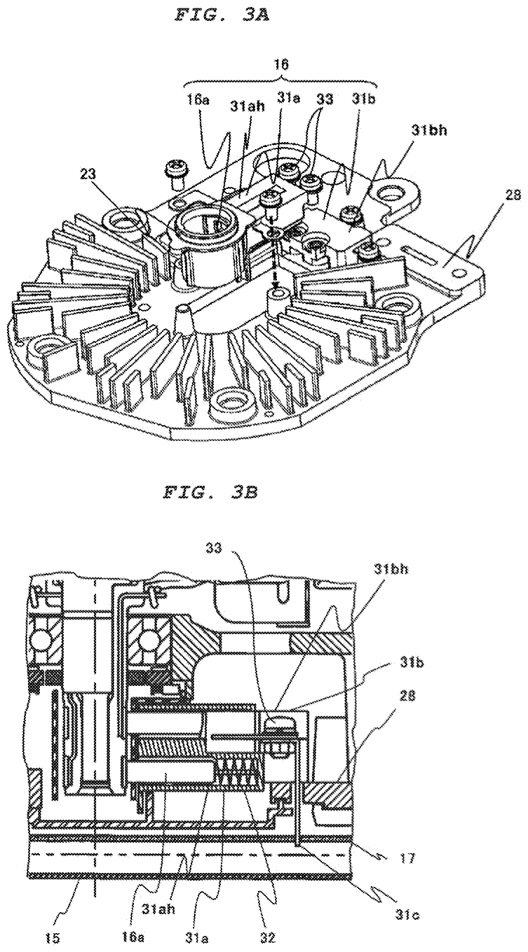

FIG. 3A is a view showing the second embodiment of the present application, and is a perspective view of the front of a rotating electrical machine. FIG. 3B is a view showing the second embodiment of the present application, and is a partial cross-sectional view of a main part in FIG. 3A.

However, in FIGS. 3A and 3B, components being similar elements of the first embodiment are designated by the same reference numerals as in the first embodiment.

Since the basic configuration is the same as that of the first embodiment, the description thereof will be omitted.

The brush holder 16 is divided into a brush holder assembly 31b (control module side), which is the second brush holder assembly fixed to the substrate in the control module 17 with solder via the terminal and a brush holder assembly 31a (brush built-in side), which is the first brush holder assembly containing the brush 16a, and, the brush holder assembly 31a, and the first brush holder assembly 31a (brush built-in side) and the second brush holder assembly 31b (control module side) are fixed to each other by a binder such as a screw.

The second brush holder assembly 31b is fixed to the control module 17 with solder, and is screwed to the heat sink 28.

The first brush holder assembly (brush built-in side) 31a is fixed to the heat sink 28 and the second brush holder assembly 31b with a removable mounter such as a screw so that the first brush holder assembly 31a can be removed by itself.

An outer casing 31ah of the first brush holder assembly 31a and an outer casing 31bh of the second brush holder assembly 31b are both molded of a resin having good thermal conductivity and electrical insulation.

As described above, according to the second embodiment, the brush holder 16 is divided into a first brush holder assembly 31a containing the brush 16a and a second brush holder assembly 31b which is a board connection part, since the first brush holder assembly 31a containing the brush 16a has a structure that can be removed from the heat sink 28 with screws, in the event of brush noise or brush wear, only the first brush holder assembly 31a containing the brush can be easily replaced, and productivity and maintainability can be improved.

### Third Embodiment

The third embodiment of the present application will be described.

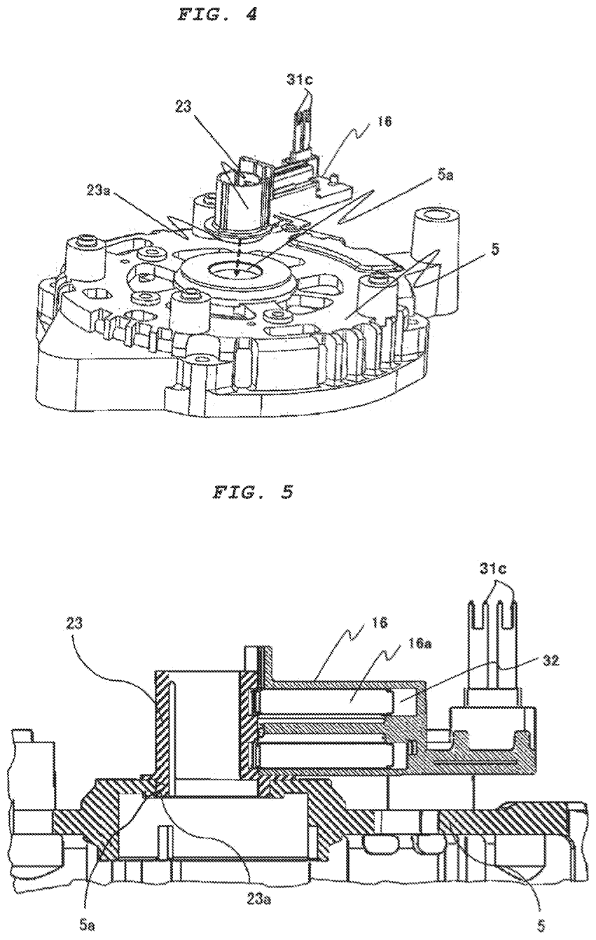

FIG. 4 is a view showing the third embodiment of the present application, and is a front perspective view of the bracket rear and the brush holder, and FIG. 5 is a view showing the third embodiment of the present application after assembling the brush holder to the bracket rear, and is a cross-sectional view of the bracket rear and the brush holder.

The slinger 23 is configured to fit into the brush holder 16 on the rotation shaft side of the brush holder 16, and has a role of controlling the protruding state of the brush 16a and preventing foreign matter from entering from the outside.

The slinger 23 is provided with a slinger projection part 23a on the front side, the slinger projection part 23a has a structure of being fitted into a rear bracket rear hole 5a, which is a mounting part provided on the central axis side of the rear bracket 5. In this case, the relationship between the unevenness of the slinger 23 and the rear bracket 5 may be reversed.

As described above, according to the third embodiment, as the rear end of the rotating shaft 11 is concentrically and rotatably fitted inside of the cylindrical slinger and the cylindrical slinger 23 whose inner peripheral surface surrounds the slip ring 13 through the gap is fitted into the hole on the rear side of the rear bracket 5 and the hole of the heat sink 28, moisture that has entered the inside of the rotating electrical machine with integrated control device becomes difficult to enter around the brush, therefore, it is possible to prevent deterioration of electrical characteristics due to water exposure, further, since the slinger 23 is attached to the heat sink 28 detachably fixed to the rear side of the rear bracket 5 via the case 14, the accuracy of the radial position between the central axis of the rear bracket 5 and the central axis of the cylindrical slinger 23 is stable, dimensional stability can be achieved in both the extending direction and the radial direction of the central axis.

### Fourth Embodiment

The fourth embodiment of the present application will be described.

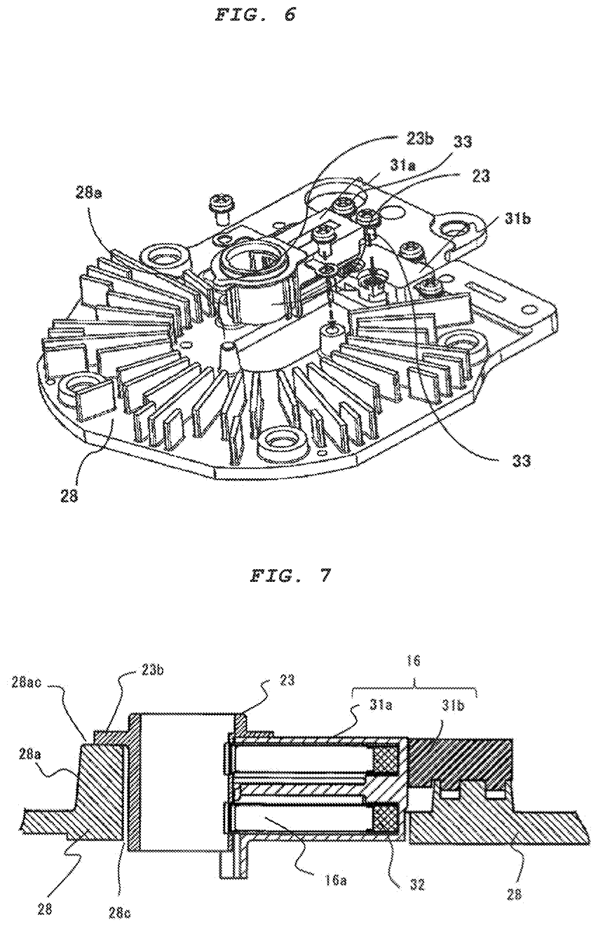

FIG. 6 is a view showing the fourth embodiment of the present application, and is a front perspective view of the heat sink and the brush holder, and FIG. 7 is a view showing the fourth embodiment of the present application after assembling the brush holder to the heat sink, and is a cross-sectional view of the heat sink and the brush holder.

Since the basic configuration is the same as that of the third embodiment, the description thereof will be omitted.

The slinger 23 is provided with a slinger flange part 23b, the slinger flange part 23b has a structure in which surface contact is made with a surface contact part 28ac of the front end surface of a heat sink projection part 28a provided on the front side of the heat sink 28, when the slinger 23 is fixed from the front side, the heat sink projection part 28a and the slinger flange part 23b come into contact with each other.

Furthermore, the slinger 23, which is positioned in the axial direction by abovementioned contact, is provided by a fitting such as a screw, it is mounted indirectly through the brush holder 16 or directly on the mounting part of the heat sink 28 without passing through the brush holder 16, alternatively, the slinger 23 is mounted by being fitted into a through hole 28c, which is a mounting part provided concentrically with the slinger 23 and the rotating shaft 11 in the central part of the heat sink 28.

As described above, according to the fourth embodiment, since the slinger flange part 23b projecting from the front side of the outer peripheral surface of the slinger 23 is in surface contact with the surface contact part 28ac on the front end surface of the axially projection part of the heat sink 28 in the axial direction, the variation in the position in the height direction (axial direction) in the figure of the slinger 23 is reduced, and the position accuracy in the height direction (axial direction) of the slinger 23 and the brush holder 16 in the figure is stable, it becomes possible to achieve the dimensional stability of the axle and radial of the assembly composed of the heat sink 28, the slinger 23 and the brush holder 16.

### Fifth Embodiment

The fifth embodiment of the present application will be described.

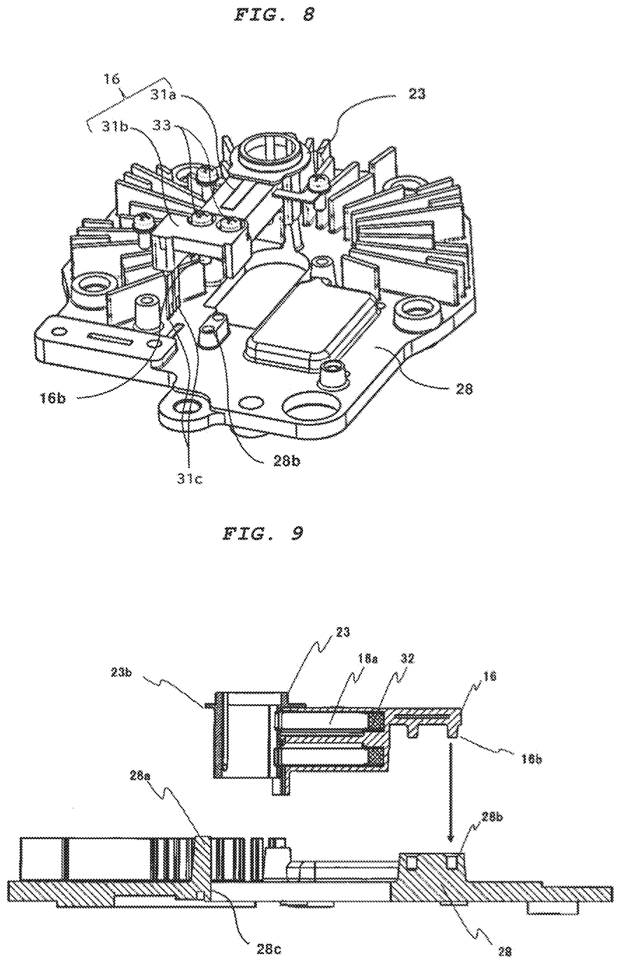

FIG. 8 is a view showing the fifth embodiment of the present application, and is a front perspective view of the heat sink and the brush holder, and FIG. 9 is a view showing the fifth embodiment of the present application before assembly, and is a cross-sectional view of the heat sink and the brush holder.

Since the basic configuration is the same as that of the third embodiment, the description thereof will be omitted.

The brush holder 16 is provided with one or more protruding part 16b for positioning the brush holder with the heat sink 28, the heat sink 28 is provided with one or more heat sink positioning recess part 28b into which the brush holder positioning protruding part 16b are fitted. The brush holder positioning protruding part 16b is fitted into the heat sink positioning recess part 28b.

In this case, the relationship between the unevenness of the brush holder 16 and the heat sink 28 may be reversed.

As described above, according to the fifth embodiment, the relative position of the brush holder 16 and the heat sink 28 is stabilized by the uneven fitting by the heat sink positioning recess part 28b and the brush holder positioning protruding part 16b, the accuracy of the relative position between the inverter assembly 30 and the brush holder 16 is stabilized via the heat sink 28, it is possible to achieve dimensional stability in the radial and axial directions of the structure including the inverter assembly 30 and the brush holder 16.

### Sixth Embodiment

The sixth embodiment of the present application will be described.

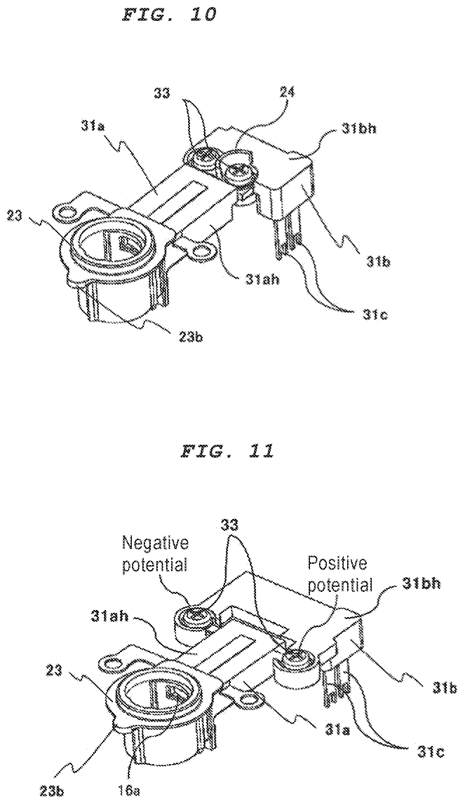

FIG. 10 is a view showing the second embodiment of the present application, and is a front perspective view of the brush holder.

In the first brush holder assembly (built-in brush side) 31a and the second brush holder assembly (control module connection side) 31b, are fixed to each other by the first terminals 33 and 33 which are engaging elements such as a pair of screws one of which has a positive potential and the other has a negative potential.

The pair of first terminals 33, 33 have different potentials, and an inter-terminal insulating wall 24 for taking a creeping distance is provided between the pair of first terminals 33, 33 as shown in FIG. 10.

The terminal-to-terminal insulating wall 24 is cast integrally with the outer casing 31b of the second brush holder assembly (control module connection side) 31b.

Further, as a power supply path, a current flows from the field module 10 through the control module 17, and further via a second terminal 31c of the second brush holder assembly (control module connection side) 31b, at the first terminals 33 and 33, through the brush 16a built in the first brush holder assembly (brush built-in side) 31a, and the current flows from the brush 16a to the drive unit 29.

As described above, according to the sixth embodiment, since it is possible to reduce the fact that salt water may be applied to the pair of fixed connecting members and to keep a creeping distance between the pair of fixed connecting members when water is received, deterioration of electrical reliability due to electrolytic corrosion when exposed to water is prevented, and it is possible to improve the electrical reliability of the product.

### Seventh Embodiment

The seventh embodiment of the present application will be described.

FIG. 11 is a view showing the seventh embodiment of the present application, and is a front perspective view of the brush holder.

Since the basic configuration is the same as that of the sixth embodiment, the description thereof will be omitted.

In the first brush holder assembly 31a and the second brush holder assembly 31b are integrally detachably and integrally connected to each other by the first terminals 33 and 33 which are engaging elements such as a pair of screws one of which has a positive potential and the other has a negative potential.

The pair of first terminals 33, 33 and the brush 16a are electrically connected to each other, a current flowing from the field module 10 via the control module 17 through the second terminal 31c which is partially incorporated in the second brush holder assembly 31b, flows through the brush 16a via the pair of first terminals 33, 33.

As shown in FIG. 7 these pair of first terminals 33, 33 are arranged on both sides of the first brush holder assembly 31a in the horizontal direction when the longitudinal direction of the brush 16a (see, for example, FIG. 1) (the longitudinal direction of the first brush holder assembly 31a incorporating the brush 16a) is vertical.

As described above, according to the seventh embodiment, when the longitudinal direction of the brush 16a (the longitudinal direction of the first brush holder assembly 31a incorporating the brush 16a) is set to the vertical direction in the first brush holder assembly 31a incorporating the brush 16a, by arranging the first terminals 33, 33 having different potentials on both sides of the first brush holder assembly 31a in the horizontal direction, it reduces the effect of being flooded between different potentials in an environment that may be flooded, and it is possible to prevent a decrease in electrical reliability due to electrolytic corrosion between the first terminals 33 and 33, and to improve the electrical reliability of the product.

### Eighth Embodiment

The eighth embodiment of the present application will be described.

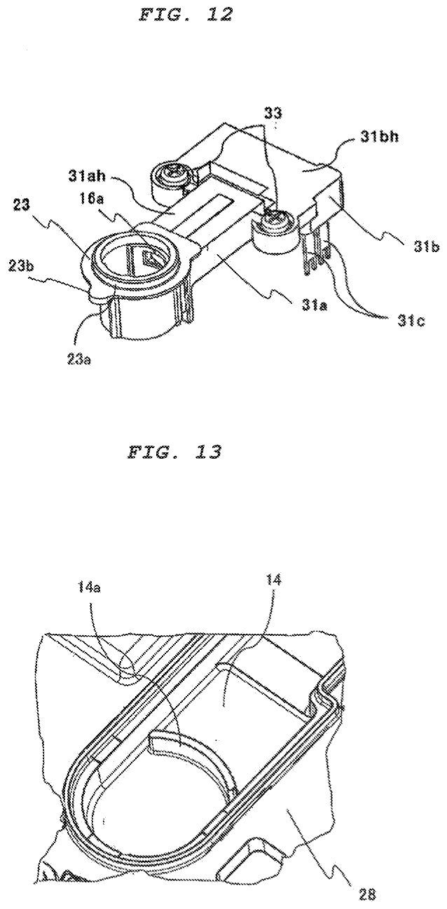

FIG. 12 is a view showing the eighth embodiment of the present application, and is a front perspective view of the brush holder.

Since the basic configuration is the same as that of the sixth embodiment, the description thereof will be omitted.

In a state where the second brush holder assembly 31b having the second terminal 31c connected to the control module 17 is fixed to the heat sink 28 by a fixing member such as a screw or an adhesive (not shown), the first brush holder assembly 31a containing the brush 16a is fixed to the second brush holder assembly 31b having the second terminal 31c connected to the control module 17 with only a pair of first terminals 33, 33, the first brush holder assembly 31a containing the brush 16a does not have a fixing part with the heat sink 28 and has no fixing part, furthermore, in a state where the slinger projection part 23a of the slinger 23 which is fitted and fixed to the first brush holder assembly 31a, and, as shown in FIGS. 6 and 7 of the fourth embodiment, in the state where the slinger flange part 23b provided with a periphery of the slinger projection part 23a is contacting with the heat sink and holding the slinger projection part 23a in the height direction at the slinger flange part 23b, and in a state where the first brush holder assembly 31a is not directly fixed to the heat sink 28 by a fixing member such as a screw, it is fixed to the heat sink 28 via the slinger 23 and the second brush holder assembly 31b.

As described above, according to the eighth embodiment, in a state where the second brush holder assembly 31b is fixed to the heat sink 28 with a fixing member such as a screw or an adhesive, the first brush holder assembly 31a is not directly fixed to the heat sink 28 and is not directly fixed, and is indirectly fixed to the heat sink 28 via the first terminal 33, which is a fixing member with the second brush holder assembly 31b, and the slinger flange part 23b of the slinger. Without having a structure in which the first brush holder assembly 31a containing the brush 16a is directly fixed to the heat sink 28, by adopting a structure that is indirectly fixed, the number of screw points can be reduced, and the product cost can be reduced, in addition, by reducing the number of fixing screws that are charged, it is possible to prevent electrical reliability because of electrolytic corrosion.

### Ninth Embodiment

The ninth embodiment of the present application will be described.

FIG. 13 is a view showing the ninth embodiment of the present application, and is a front perspective view of the case, and FIG. 14 is a view showing the ninth embodiment of the present application after assembly, and is a cross-sectional view of the case and the brush holder as viewed from the front.

On the front side of the case 14 in the inverter assembly 30, a projection part 14a protruding convexly toward the brush holder 16 side is provided integrally with the case 14 (see also FIGS. 1A and 1B). The width of the projection part 14a is formed to be larger than the width of the brush holder 16. In the state where the rotating electrical machine with integrated control device is mounted on a vehicle, the projection part 14a is located on the top side of the brush holder 16 so as to cover the brush holder 16, and has a convex shape on the side opposite to the brush holder 16. The convex shape of the projection part 14a is formed in an arc as shown in FIG. 14 or a reversed V shape.

As described above, according to the ninth embodiment, in a case where salt water or the like that has passed through the case 14 or the heat sink 28 from the top side comes into contact with the wall provided on the case 14, it falls along the wall in the direction of the ground, since the horizontal width of the projection part 14a is larger than the horizontal width of the brush holder 16, the possibility that the brush holder 16 is exposed to water can be reduced, further, since it is formed of an arc or a reversed V shape, the water drainage property is improved when it is exposed to water, so that it is possible to prevent the electrical reliability due to the influence of electrolytic corrosion.

### Tenth Embodiment

The tenth embodiment of the present application will be described.

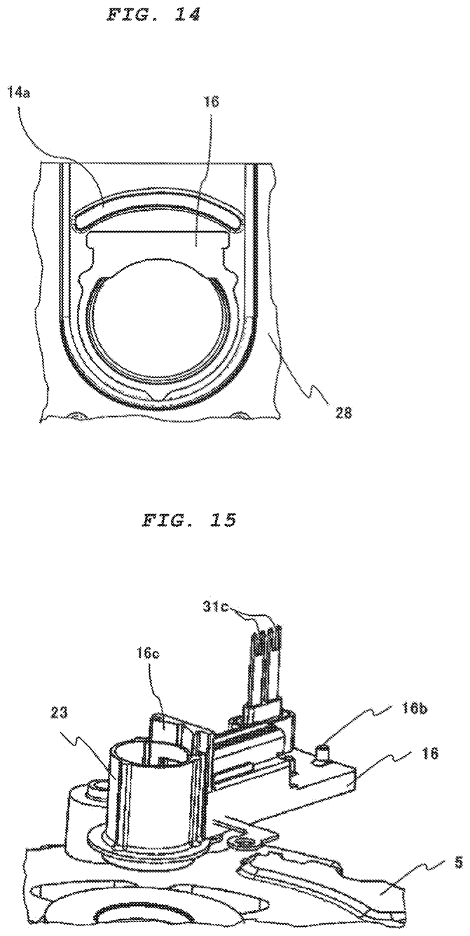

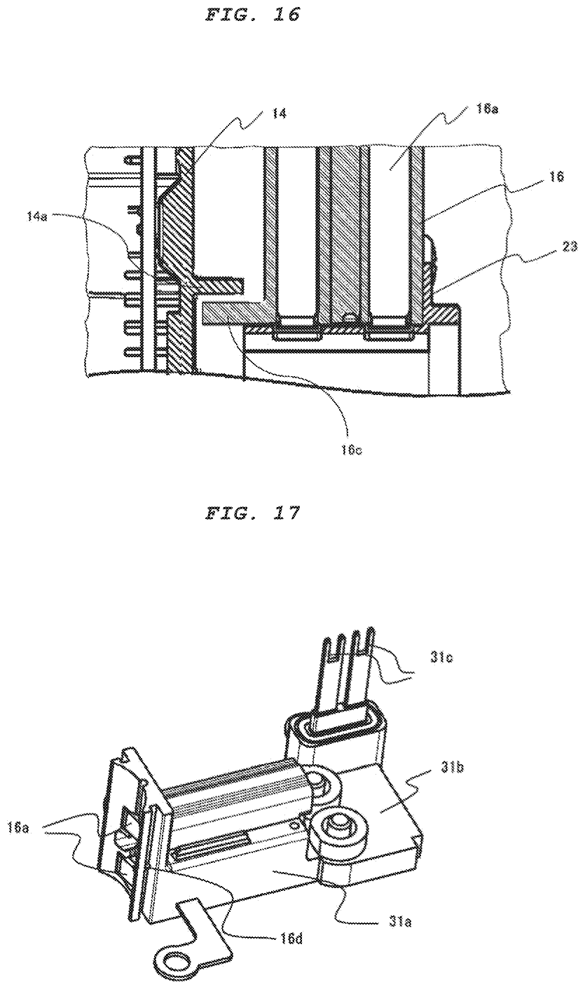

FIG. 15 is a view showing the tenth embodiment of the present application, and is a rear perspective view of the brush holder, and FIG. 16 is a view showing the tenth embodiment of the present application, and is a cross-sectional view of the case and the brush holder.

Since the basic configuration is the same as that of the ninth embodiment, the description thereof will be omitted.

The brush holder 16 is provided with a convex shape brush holder waterproofing protruding part 16c on the case 14 side.

The brush holder waterproof protruding part 16c has a labyrinth structure (see FIG. 16) and the projection part 14a of the case 14 on the front side, which is a part of the wall shown in the ninth embodiment.

As described above, according to the tenth embodiment, when salt water or water that have been flooded from the top flows down, by forming the projection part 14a on the front side, which is a part of the case 14, and the protruding part 16c for waterproofing the brush holder in a stepped manner, the possibility of moisture adhering to the charged part of the brush holder 16 is reduced, and it is possible to improve the electrical reliability.

### Eleventh Embodiment

The eleventh embodiment of the present application will be described.

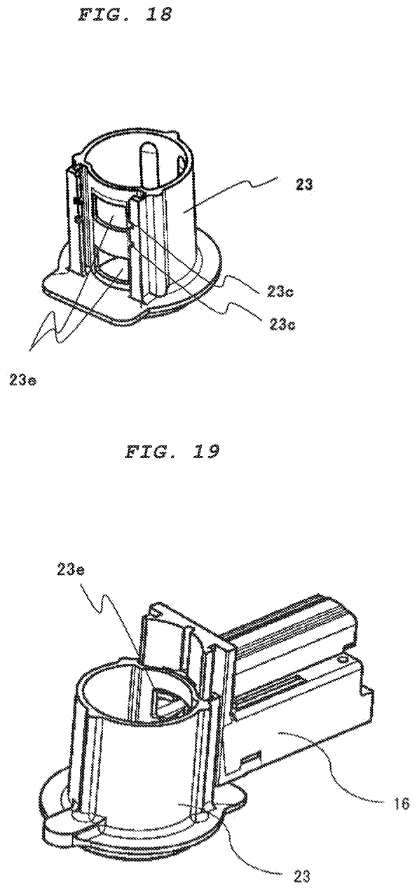

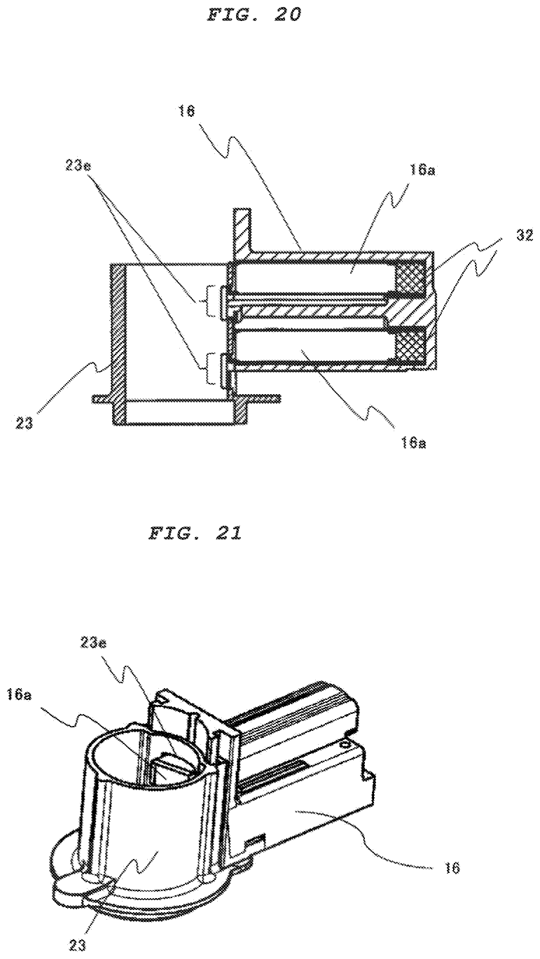

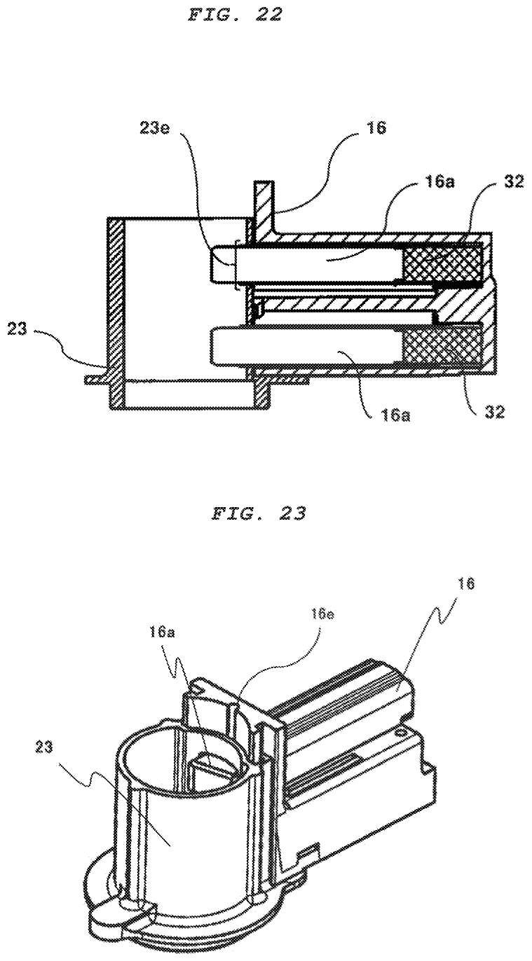

FIG. 17 is a view showing the eleventh embodiment of the present application, and is a rear perspective view of a brush holder, FIG. 18 is a view showing the eleventh embodiment of the present application, and is a rear perspective view of a slinger, FIG. 19 is a view showing the eleventh embodiment of the present application, and is a rear perspective view of a slinger fitted in a step of the first step of the brush holder, FIG. 20 is a view showing the eleventh embodiment of the present application, and is a cross-sectional view of a brush protrusion suppressed by a slinger, FIG. 21 is a view showing the eleventh embodiment of the present application, and is a rear perspective view of a slinger fitted in a second step of the brush holder, FIG. 22 is a view showing the eleventh embodiment of the present application, and is a cross-sectional view of a state in which the brush protrusion is not suppressed by the slinger.

The slinger 23 has a configuration in which a pair of fitting portions of the slinger 23a is fitted into grooves in the axial direction of the brush holder 16 using the grooves as guide as shown in FIGS. 19 and 21, the slinger 23 has recess part 23c for position regulation with two or more brush holders, the position-regulating recess part 23c with the brush holder of the slinger 23 is arranged parallel to the axial direction on the pair of fitting portions of the slinger 23a as shown in FIGS. 19 and 21, further, the brush holder 16 has one or more position-regulating protruding parts 16d in the grooves as shown in FIG. 17, the position-regulating protruding part 16d of the brush holder 16 has a structure of fitting into the position-regulating recess part 23c of the slinger 23. In other words, 16d is a protruding part for position regulation of the brush holder 16 with the slinger 23.

For example, when the slinger 23 is provided with two position-regulating recess parts 23c and 23c and the brush holder 16 is provided with one position-regulating protruding part 16d, assuming that the brush holder 16 is fixed, when the slinger 23 is moved toward the brush holder 16 in the axial direction and assembled with the brush holder 16, the first-stage position-regulating recess part 23c of the slinger 23 fits into the position-regulating protruding part 16d of the brush holder 16, and the slinger 23 is temporarily fixed.

By pushing the slinger 23 further from the temporarily fixed position, the slinger 23 has a structure that moves until the second-stage position-regulating recess part 23c of the slinger 23 fits into the position-regulating protruding part 16d of the brush holder 16. A force by a spring 32 is always applied to the brush 16a built in the brush holder 16 toward the central axis side.

The relationship between the unevenness of the brush holder 16 and the slinger 23 may be reversed.

Since the brush 16a is always exerted on the central axis side by the spring 32, due to the positional relationship between the slinger 23 and a brush relief hole 23e provided in the circumferential direction of the slinger, the projection state of the brush 16a toward the central axis changes.

In FIG. 17, reference numeral 31c is a second terminal serving as a connecting part between the second brush holder assembly (control module connecting side) 31b and the control module 17 (see FIG. 1A).

As described above, according to the eleventh embodiment, the slinger can be temporarily positioned on the brush holder in multiple stages, at this time, the brush stored in the brush holder can limit the state in which the brush protrudes when the slinger moves in multiple stages, for example, in the first stage position regulation, the brush does not protrude when it comes into contact with the slinger, and in the second stage of position regulation, the brush protrudes toward the central axis from the hole provided in the slinger, the projection state of the brush can be regulated by the positional relationship with the hole.

### Twelfth Embodiment

The twelfth embodiment of the present application will be described.

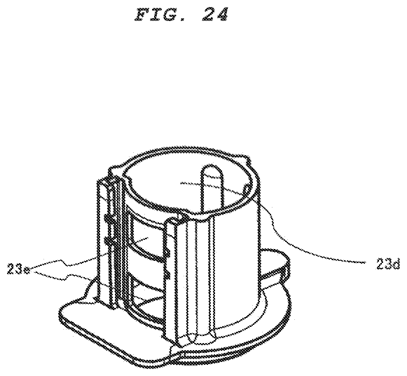

FIG. 23 is a view showing the twelfth embodiment of the present application, and is a rear perspective view of the slinger and the brush holder.

The brush holder 16 has a hole 16e provided in the axial direction for pushing the brush 16a during assembly.

When incorporating the brush 16a and the slinger 23 into the brush holder 16, the brush 16a is first pressed from the central axis side, it is held down by a jig such as a pin, and the pin is put in the hole 16e for the brush holder assembly.

The slinger 23 is incorporated into the brush holder 16 with the pins housed in the holes 16e for the brush holder assembly, the state of the brush 16a is regulated by performing the multi-step position regulation as in the eleventh embodiment.

With the position of the brush 16a regulated by the slinger 23, by pulling out a jig such as a pin housed in the hole 16e for the brush holder assembly, and an assembled structure of the brush holder 16 and the slinger 23 in a state where the brush 16a does not protrude can be obtained.

As described above, according to the twelfth embodiment, since the brush 16a can be built in the brush holder without protruding, it is installed in the inverter in this state, by regulating the multi-stage position posture of the slinger by the pushing force when it is incorporated in the drive unit, the brush can protrude when installed, it becomes possible to control the protruding state of the brush 16a only by the height relationship (change of relative position in the height direction) between the first brush holder assembly 31a incorporating the brush 16a and the slinger 23 incorporated in the first brush holder assembly 31a, it is not necessary to use a jig or a tool to suppress the protruding state of the brush, and it is possible to control the protruding state of the brush without using any parts other than the slinger.

### Thirteenth Embodiment

The thirteenth embodiment of the present application will be described.

FIG. 24 is a view showing the thirteenth embodiment of the present application, and is a rear perspective view of the slinger.

As illustrated in FIG. 24, the slinger 23 has a slinger release part 23d formed on the rear side in the axial direction, and the rear side in the axial direction is open.

Although it is clear as shown in the figure that the slinger release part is formed in the corresponding drawings of the other first to twelfth embodiments described above, the reference sign 23d is omitted from the figure.

As described above, according to the thirteenth embodiment, the brush 16a built in the brush holder 16 is always in contact with the slip ring 13 in a pressurized state by the spring 32 during operation of the rotating electrical machine.

The main component of the brush 16a is copper powder, and when the rotor 2 is rotated, the brush 16a generates fine powder due to sliding with the slip ring in the pressurized state, if the powder collects between the different potential parts near the brush 16a, there is a risk of electrical short circuit, but the slinger release part 23d on the axial rear side of the slinger 23 is formed, by opening the rear side of the slinger 23 in the axial direction, when brush powder is generated, the powder is scattered in the space on the case 14 side, so that the powder is scattered, since it is difficult to electrically short-circuit between the different potential parts near the brush 16a, it is possible to prevent the powder of the brush from accumulating and improve the electrical reliability.

The technical features of each of the above embodiments are listed below.

### Characteristic Point 1-1:

A rotating electrical machine with integrated control device providing;

a rotor held rotatably including a field winding, a field core that covers the field winding, and a slip ring for supplying the field current to the field winding, wherein the rotor is equipped with centrifugal fans on both sides and is arranged around the rotor,

a stator with an armature winding,

a pulley for transferring torque between the rotor and the internal combustion engine,

a pair of bearings for holding the rotor rotatably,

front and rear housings that hold the bearings and the stator from both sides of the axle,

a power module in which a switching element for energizing the stator is placed on a lead frame for electrical wiring and molded with a resin material,

a field module in which a switching element for supplying a field current is placed on a lead frame for electrical wiring and molded with a resin material,

a control module equipped with a control circuit that controls switching elements,

an inverter assembly consisting of a heat sink for cooling the power module and the field module, a brush holder that holds the brush to supply current to the slip ring and the rotation sensor which consist of a sensor rotor fixed to the rotor shaft and rotation detector that detects the rotation position in order to detect the rotation position of the rotor, and a cover to protect the inverter assembly,

the inverter assembly is characterized in that there is no hole in the center of the control module and the case, and the brush holder is assembled from the front side to the heat sink with screws.

### Characteristic Point 1-2:

Inverter assembly characterized in that the brush holder is divided into the brush holder assembly that contains the brush and the brush holder assembly fixed to the board with solder via the terminal, each brush holder assembly is fixed with screws, the brush holder assembly fixed to the control module with solder is fixed to the heat sink and case, and the brush holder assembly containing the brush is fixed to the heat sink with a removable object such as a screw so that it can be removed.

### Characteristic Point 1-3:

The inverter assembly is characterized in that the brush holder has a slinger built in, and the protruding part provided on the slinger has the structure that fits into the recess part provided on the rear bracket. The relationship between the unevenness may be reversed.

### Characteristic Point 1-4:

The inverter assembly is characterized in that the slinger is provided with a flange, the heat sink has a protrusion that comes into contact with the slinger, and the heat sink and the slinger are in surface contact with each other.

### Characteristic Point 1-5:

The inverter assembly is characterized in that the brush holder is provided with one or more convex shape for positioning, and the heat sink has a recess part for fitting the convex shape of the brush holder. The relationship between the unevenness may be reversed.

### Characteristic Point 1-6:

The inverter assembly is characterized that the connecting part connecting the brush holder assembly containing the brush to the brush holder fixed to the board with solder via the terminal has the insulating wall between its connections.

### Characteristic Point 1-7:

The inverter assembly is characterized in that the pair of fixed parts is provided on the connecting part connecting the brush holder assembly containing the brush to the brush holder fixed to the board with solder via the terminal, the fixed parts are arranged on both sides of the brush holder with the longitudinal direction of the brush as the axis reference.

### Characteristic Point 1-8:

The inverter assembly is characterized by fixing the brush holder only with the height presser fixed to the bracket via the slinger, and by fixing with the removable object such as the screw at the connection point of the brush holder assembly with the built-in brush and the brush holder assembly fixed to the board via the terminal with solder.

### Characteristic Point 1-9:

The inverter assembly is characterized in that it has a convex shape part that protrudes to the front side of the case, its width is larger than the width of the brush holder, further, the rotating electrical machine with integrated control device is placed on the top side when mounted on the vehicle, and the convex shape part is composed of the arc or the reversed V-shape.

### Characteristic Point 1-10:

The inverter assembly is characterized in that the brush holder has the convex shape on the case side, and this convex shape has the labyrinth structure with the wall provided on the case side.

### Characteristic Point 1-11:

The inverter assembly is characterized in that the slinger has two or more recess parts, the recess parts are arranged parallel to the axial direction, and the brush holder has one or more protruding parts, the protruding part of the brush holder fits into the recess part of the slinger, the slinger is position regulated in multiple stages, at this time, the brush built into the brush holder assembly is in a positional relationship that touches or does not touch the slinger, and it regulates the protruding state according to the position of the slinger.

### Characteristic Point 1-12:

The inverter assembly is characterized in that the brush holder has a hole for storing the members used when assembling the brush.

### Characteristic Point 1-13:

The inverter assembly is characterized in that the slinger is axially opened.

Further the conceptual technical features of each of the above embodiments are listed below.

### Characteristic Point 2-1:

The rotating electrical machine with integrated control device is characterized in that it provides the drive unit having the rotor having the field winding, the stator and the rear bracket, and the inverter assembly arranged on the rear side of the drive unit and having the slip ring provided on the outer circumference of the rotating shaft of the rotor, the field module that supplies the field current to the field winding via the brush that is in sliding contact with the slip ring, heat sink thermally connected to the field module, and the control module disposed on the rear side of the heat sink for controlling the field current by controlling the field module, furthermore, the brush holder that holds the brush is detachably attached to either the rear bracket side of the inverter assembly or the inverter assembly side of the rear bracket.

### Characteristic Point 2-2:

The rotating electrical machine with integrated control device is characterized in that the brush holder is configured with the first brush holder assembly containing the brush and the second brush holder assembly detachably attached to either the rear bracket side of the inverter assembly or the inverter assembly side of the rear bracket, and the first brush holder assembly and the second brush holder assembly are detachably connected with the engager.

### Characteristic Point 2-3:

The rotating electrical machine with integrated control device is characterized in that the cylindrical slinger that surrounds the axis of rotation is incorporated on the side where the brush of the brush holder protrudes, the slinger is detachably fitted to either the rear bracket side of the inverter assembly or the inverter assembly side of the rear bracket.

### Characteristic Point 2-4:

The rotating electrical machine with integrated control device is characterized in that the cylindrical slinger that surrounds the axis of rotation is incorporated on the side where the brush of the brush holder protrudes, the slinger is detachably fitted to either the rear bracket side of the inverter assembly or the inverter assembly side of the rear bracket, the slinger is provided with the flange, and the heat sink is provided with the projection part that makes surface contact with the flange part.

### Characteristic Point 2-5:

The rotating electrical machine with integrated control device is characterized in that the protruding part for positioning of the brush holder is provided on either the brush holder or the heat sink, on the other hand, the recess part for positioning of the brush holder is provided, the brush holder positioning protruding part is fitted into the brush holder positioning recess part.

### Characteristic Point 2-6:

The rotating electrical machine with integrated control device is characterized in that the brush holder is provided with an insulation wall between terminals that insulates the pair terminals of the brush holder from each other.

### Characteristic Point 2-7:

The rotating electrical machine with integrated control device is characterized in that the pair of terminals of different potentials of the brush holder are arranged on both sides of the brush holder with the longitudinal direction of the brush as the axis reference.

### Characteristic Point 2-8:

The rotating electrical machine with integrated control device is characterized in that the brush holder is configured with the first brush holder assembly containing the brush and the second brush holder assembly detachably attached the first brush holder assembly, the first brush holder assembly is coupled to the cylindrical slinger that surrounds the axis of rotation, and the second brush holder assembly is detachably attached to either the rear bracket side of the inverter assembly or the inverter assembly side of the rear bracket.

### Characteristic Point 2-9:

The rotating electrical machine with integrated control device is characterized in that the projection part located on the top side of the brush holder to prevent water from being exposed to the brush holder is mounted on the inverter assembly side.

### Characteristic Point 2-10:

The rotating electrical machine with integrated control device is characterized in that the protruding part for waterproofing the brush holder is provided on the control module side of the brush holder, the projection part is provided on the rear side of the brush holder and extends to the front side, and the brush holder waterproof protruding part and the projection part have the labyrinth structure between each other.

### Characteristic Point 2-11:

The rotating electrical machine with integrated control device is characterized in that the protruding part for position regulation is provided on one of the corresponding part of the brush holder with the slinger and the corresponding part of the slinger with the brush holder, and the recess part for position regulation is provided on the other side, and the brush holder and the slinger have the position regulation in a plurality of stages by the position-regulating protruding part and the position-regulating recess part.

### Characteristic Point 2-12:

The rotating electrical machine with integrated control device is characterized in that the hole for inserting and removing the jig that regulates the position of the brush in the moving direction is provided on the surface of the brush holder facing the outer peripheral surface of the slinger.

### Characteristic Point 2-13:

The rotating electrical machine with integrated control device is characterized in that the slinger is axially opened.

In the drawings, the same reference numerals indicate the same or corresponding parts.

Although the present application is described above in terms of an exemplary embodiment, it should be understood that the various features, aspects and functionality described in the embodiment are not limited in their applicability to the particular embodiment with which they are described, but instead can be applied, alone or in various combinations to the embodiment. It is therefore understood that numerous modifications which have not been exemplified can be devised without departing from the scope of the present application. For example, at least one of the constituent components may be modified, added, or eliminated.

It should be noted that each embodiment can be appropriately combined, modified, or omitted.

### REFERENCE SIGNS LIST

1: Rotating electrical machine with integrated control device
2: Rotor
2a: Field winding
2b: Field core
3: Stator
3a: Three-phase stator winding
4: Front bracket
5: Rear bracket
5a: Rear bracket rear hole
6: Magnetic pole position detection sensor
6a: Sensor stator
6b: Sensor rotor
7: Bearing
8: Bearing
9: Rectifier module
10: Field module
11: Rotating shaft
12: Pulley
13: Slip ring
14: Case
14a: Projection part
15: Cover
16: Brush holder
16a: Brush
16b: Brush holder positioning protruding part
16c: Brush holder waterproof protruding part
16d: Position regulation protruding part
16e: Hole
17: Control module
18: Connecting board
20: Fan
21: Fan
22: Screw
23: Slinger
23a: Slinger projection part
23b: Slinger flange part
23c: Position regulation recess part
23d: Slinger release part
23e: Brush relief hole
24: Insulation wall between terminals
28: Heat sink
28a: Heat sink projection part
28ac: Surface contact part
28b: Heat sink position regulation recess part
28c: Through hole
29: Drive unit
30: Inverter assembly
31a: First brush holder assembly
31ah: Outer casing
31b: Second brush holder assembly
31bh: Outer casing
31c: Second terminal
32: Spring
33: First terminal

1. A rotating electrical machine with integrated control device comprising:
a drive unit having a rotor having a field winding, a stator and a rear bracket, and
an inverter assembly arranged on the rear side of the drive unit and having a slip ring provided on the outer circumference of the rotating shaft of the rotor, a field module that supplies a field current to the field winding via a brush that is in sliding contact with the slip ring, heat sink thermally connected to the field module, and a control module disposed on the rear side of the heat sink for controlling the field current by controlling the field module,
wherein; a brush holder that holds the brush is detachably attached to either the rear bracket side of the inverter assembly or the inverter assembly side of the rear bracket.

2. The rotating electrical machine with integrated control device according to claim 1, wherein;
the brush holder is configured with a first brush holder assembly containing the brush and a second brush holder assembly detachably attached to either the rear bracket side of the inverter assembly or the inverter assembly side of the rear bracket, wherein the first brush holder assembly and the second brush holder assembly are detachably connected with an engager.

3. The rotating electrical machine with integrated control device according to claim 1, wherein;
the cylindrical slinger that surrounds the axis of rotation is incorporated on the side where the brush of the brush holder protrudes, the slinger is detachably fitted to either the rear bracket side of the inverter assembly or the inverter assembly side of the rear bracket.

4. The rotating electrical machine with integrated control device according to claim 2, wherein;
the cylindrical slinger that surrounds the axis of rotation is incorporated on the side where the brush of the brush holder protrudes, the slinger is detachably fitted to either the rear bracket side of the inverter assembly or the inverter assembly side of the rear bracket.

5. The rotating electrical machine with integrated control device according to claim 1, wherein;
the cylindrical slinger that surrounds the axis of rotation is incorporated on the side where the brush of the brush holder protrudes, the slinger is detachably fitted to either the rear bracket side of the inverter assembly or the inverter assembly side of the rear bracket, wherein
the slinger is provided with a flange,
the heat sink is provided with a projection part that makes surface contact with the flange part.

6. The rotating electrical machine with integrated control device according to claim 2, wherein;
the cylindrical slinger that surrounds the axis of rotation is incorporated on the side where the brush of the brush holder protrudes, the slinger is detachably fitted to either the rear bracket side of the inverter assembly or the inverter assembly side of the rear bracket, wherein
the slinger is provided with a flange,
the heat sink is provided with a projection part that makes surface contact with the flange part.

7. The rotating electrical machine with integrated control device according to claim 5, wherein;
a protruding part for positioning of the brush holder is provided on either the brush holder or the heat sink, on the other hand, a recess part for positioning of the brush holder is provided, the brush holder positioning protruding part is fitted into the brush holder positioning recess part.

8. The rotating electrical machine with integrated control device according to claim 1, wherein;
the brush holder is provided with an insulation wall between terminals that insulates the pair terminals of the brush holder from each other.

9. The rotating electrical machine with integrated control device according to claim 7, wherein;
the brush holder is provided with an insulation wall between terminals that insulates the pair terminals of the brush holder from each other.

10. The rotating electrical machine with integrated control device according to claim 1, wherein;
a pair of terminals of different potentials of the brush holder are arranged on both sides of the brush holder with the longitudinal direction of the brush as an axis reference.

11. The rotating electrical machine with integrated control device according to claim 8, wherein;
a pair of terminals of different potentials of the brush holder are arranged on both sides of the brush holder with the longitudinal direction of the brush as an axis reference.

12. The rotating electrical machine with integrated control device according to claim 1, wherein;
the brush holder is configured with a first brush holder assembly containing the brush and a second brush holder assembly detachably attached the first brush holder assembly,
the first brush holder assembly is coupled to a cylindrical slinger that surrounds the axis of rotation,
the second brush holder assembly is detachably attached to either the rear bracket side of the inverter assembly or the inverter assembly side of the rear bracket.

13. The rotating electrical machine with integrated control device according to claim 1, wherein;
a projection part located on the top side of the brush holder to prevent water from being exposed to the brush holder is mounted on the inverter assembly side.

14. The rotating electrical machine with integrated control device according to claim 12 wherein;
a projection part located on the top side of the brush holder to prevent water from being exposed to the brush holder is mounted on the inverter assembly side.

15. The rotating electrical machine with integrated control device according to claim 1, wherein;
a protruding part for waterproofing the brush holder is provided on the control module side of the brush holder,
a projection part is provided on the rear side of the brush holder and extends to the front side,
the brush holder waterproof protruding part and the projection part have a labyrinth structure between each other.

16. The rotating electrical machine with integrated control device according to claim 12 wherein;
a protruding part for waterproofing the brush holder is provided on the control module side of the brush holder,
a projection part is provided on the rear side of the brush holder and extends to the front side,
the brush holder waterproof protruding part and the projection part have a labyrinth structure between each other.

17. The rotating electrical machine with integrated control device according to claim 3, wherein;
a protruding part for position regulation is provided on one of the corresponding part of the brush holder with the slinger and the corresponding part of the slinger with the brush holder, and a recess part for position regulation is provided on the other side, the brush holder and the slinger have a position regulation in a plurality of stages by the position-regulating protruding part and the position-regulating recess part.

18. The rotating electrical machine with integrated control device according to claim 3, wherein;
a hole for inserting and removing a jig that regulates the position of the brush in the moving direction is provided on a surface of the brush holder facing the outer peripheral surface of the slinger.

19. The rotating electrical machine with integrated control device according to claim 3, wherein;
the slinger is axially opened.

20. The rotating electrical machine with integrated control device according to claim 18 wherein;
the slinger is axially opened.
